(19) United States
(12) Patent Application Publication
(10) Pub. No.: US 2026/0310053 A1
(43) Pub. Date: Oct. 8, 2026

(54) MOUNTING DEVICE FOR FIXING ELECTRONIC EQUIPMENT

(71) Applicant: ICOM INCORPORATED, Osaka (JP)

(72) Inventor: Yushi KASHIWAGI, Osaka (JP)

(73) Assignee: ICOM INCORPORATED, Osaka (JP)

(21) Appl. No.: 19/460,724

(22) Filed: Jan. 27, 2026

(30) Foreign Application Priority Data
Feb. 21, 2025 (JP) 2025-026618
Apr. 28, 2025 (JP) 2025-074764

(51) Int. Cl. G03B 17/56; F16M 13/02

(52) U.S. Cl. CPC G03B 17/561; F16M 13/02

(57) ABSTRACT

In a mounting device for fixing an electronic equipment, which can easily adjust the tension of an elastic spring, ensuring the strength and durability of the spring, and can store the spring in a small and compact mount. The mounting device includes a joint that is coupled to the equipment, and a mount that holds the joint. The joint has a flange and a groove. The mount includes a cover plate and a metal leaf spring, and the cover plate is provided with a window. A protrusion is provided on the free end of the spring. The flange is inserted into a recess space through the window and rotated to press the flange between the cover plate and the spring, and the groove and the protrusion are engaged.

### CROSS-REFERENCE TO RELATED APPLICATIONS

This application claims priority to Japanese Patent Application No. 2025-026618, filed on Feb. 21, 2025, and Japanese Patent Application No. 2025-074764, filed on Apr. 28, 2025, the disclosure of which is incorporated herein by reference in its entirety.

### FIELD OF THE INVENTION

The present invention relates to a mounting device for fixing components or parts coupled to electronic equipment such as body cameras and small wireless devices.

### DESCRIPTION OF THE RELATED ART

Regarding a mounting structure for fixing a small electronic equipment such as a camera with a single touch, following mounting devices are known. The device includes a joint, which is a component coupled to the camera, and a mount that holds the joint. The shaft portion of the joint on the camera side is inserted into a recess in the mount through an opening provided on the mount, and, by rotating the joint a predetermined angle around the shaft portion, the joint is held on the mount (for example, see Non-Patent Document 1). Here, for positioning and fixing the joint, a resin elastic spring member is generally used.

Although not for electronic devices, it is known to use a metal elastic piece and fastening parts for positioning and fixing in a structure for fixing a support body to which a seat cushion is attached to a mounting part (see, for example, Patent Document 1).

In the structure for fixing the support body to the mounting part, disclosed in Patent Document 1, the fastening parts have a shaft portion and an enlarged (or expanded) diameter portion at both ends of the shaft portion. The fastening parts are inserted into the holes provided in the support body and the mounting part, and rotated around the axis. Then, the enlarged diameter portion elastically bends a raised portion of the metal elastic piece provided on the support body. The elastic repulsive force caused by the bending presses the support body and the mounting part, which are sandwiched between the enlarged diameter portion. As a result, the support body and the mounting part are fixed together.

### RELATED ART DOCUMENTS

### Non-patent Document

### Non-Patent Document 1

Gentos Co., Ltd. website URL

https://www.gentos.jp/products/series/accessory_bike_light/ph-v1/

### Patent Documents

### Patent Document 1

Japanese Patent Application Publication No. Hei 1-277513

### SUMMARY OF THE INVENTION

### Problems to be Solved by the Invention

In the mounting devices as shown in the above-mentioned Non-Patent Document 1, if the elastic spring member for positioning and fixing is an elastic piece made of resin, it is prone to wear and has problems in strength and durability. In particular, when a body camera or the like is mounted on the mount and the mount is attached to the user's clothing or belt, the fixing tension in the holding state must be appropriately adjusted so that the body camera or the like does not easily come off the mount due to human body movement or external force.

Furthermore, in the configuration shown in Patent Document 1, in which the metal elastic piece is used as an elastic spring member and the elastic repulsive force caused by bending the raised portion is utilized, the length dimension of the metal elastic piece becomes large, so as to ensure an appropriate tension of the repulsive force while maintaining the necessary strength. As a result, it is difficult to store such an elastic metal piece compactly in a mount for fixing a small electronic device such as a body camera.

Applicant of this present application, in a previous Japanese patent application, has proposed a mounting device for fixing electronic equipment that solves the above-mentioned problems by using a metal leaf spring with a three-dimensional shaped portion for tension adjustment in the elastic spring member, thereby ensuring strength and durability. It was later discovered that when the metal leaf spring proposed above was used, scratches were likely to occur on the sliding (friction) surface between a flange of a joint (components or parts coupled to an electronic equipment) and the metal leaf spring. As a result of further development to solve this problem, we discovered that tension can be adjusted using a resin elastic spring member instead of a metal leaf spring, and that the strength and durability of the sliding (friction) surface can be ensured.

Furthermore, in a specification and drawings of the previous Japanese patent application, the applicant discloses a structure in which the joint rotates around the shaft portion in a predetermined direction and by a predetermined angle when the joint is attached to or detached from the mount. This structure makes it difficult for the mount to be damaged even if the joint is rotated in the reverse direction or excessively, and contributes to durability and stable quality.

The present invention is based on the results of the above-mentioned development, and aims to provide a mounting device for fixing electronic equipment that allows tension adjustment even when using a resin elastic spring member, ensures the strength and durability of the sliding (friction) surface, and allows the elastic spring member to be stored in the mount in a small and compact manner.

Another object of the present invention is to provide a mounting device for fixing electronic equipment that has a structure in which the joint is rotated around the shaft portion in a predetermined direction by a predetermined angle, and that is less likely to damage the mount even if the joint is rotated in the reverse direction or excessively, thereby contributing to durability and stable quality.

### Means of Solving the Problems

According to a first aspect of the present invention, a mounting device for fixing electronic equipment includes:
a joint to be coupled to an exterior of the electronic equipment, and
a mount for fixing the joint;
wherein the joint includes
   a shaft portion having one end coupled to the exterior of the electronic equipment, and
   a flange located on the other end of the shaft portion, at least the flange of which extends outward with a larger diameter than the shaft portion, and a surface of the flange at the tip end in an axial direction serves as a sliding surface that slides against an elastic leaf spring described later, and the sliding surface is provided with a groove or a protrusion;
wherein the mount includes
   a recessed space,
   an elastic leaf spring fixed in the recessed space, and
   a cover plate covering the recessed space, the cover plate is provided with a window into which the flange of the joint can be inserted; wherein the elastic leaf spring has a flat portion between its fixed ends and free end, that serves as a sliding plane that slides against the sliding surface of the joint, and the free end is provided with a protrusion or a groove,
   the flange of the joint is inserted into the recessed space of the mount through the window of the cover plate, and is rotated around the axis of the joint, thereby being pressed between the cover plate and the elastic leaf spring, and
   the joint is fixed to the mount by engaging the groove or protrusion provided on the sliding surface of the flange and the protrusion or groove provided on the elastic leaf spring.

According to a second aspect of the present invention, a mounting device for fixing electronic equipment,
wherein the peripheral surface of the shaft portion of the joint is configured by combining a polygonal shape and a circular arc shape, and
an outer shape of the flange of the joint and the window of the cover plate are approximately rectangular,
the peripheral surface of the shaft portion faces the edge of the window, when the flange is inserted into the recessed space of the mount through the window,
the shaft portion can rotate without interference between the peripheral surface of the shaft portion and the edge of the window, when the shaft portion is rotated to a predetermined direction and a predetermined angle, and
the peripheral surface of the shaft portion and the edge of the window interfere with each other to prevent reverse rotation or excessive rotation, when reverse rotation or excessive rotation occurs.

According to a third aspect of the present invention, a mounting device for fixing electronic equipment,
wherein the sliding surface of the flange and the elastic leaf spring are made of metal,
the elastic leaf spring includes a pair of attachment arms having the fixed ends at diagonal positions, and a tension arm coupled to the attachment arms at a center thereof, wherein the tension arm extends in a direction perpendicular to the long side direction of the window, and its tip side is the free end,
the tension arm includes a sliding plane that slides against the sliding surface of the flange, and a 3D shaped portion that is three-dimensionally curved in a direction away from the sliding plane, and
the sliding surface of the flange and the sliding plane of the elastic leaf spring are metal-to-metal sliding friction surfaces.

According to a fourth aspect of the present invention, a mounting device for fixing electronic equipment,
wherein the elastic leaf spring is made of resin, and includes a pair of attachment arms having the fixed ends at diagonal positions, and a tension arm coupled to the attachment arms near the center, the tension arm extends in a direction perpendicular to the long side direction of the window, has a tip end side as the free end, and has a sliding flat surface that slides against the sliding surface of the flange, the sliding surface of the flange is made of metal, and the sliding surface of the flange and the sliding plane of the elastic leaf spring are sliding friction surface between metal and resin.

According to a fifth aspect of the present invention, a mounting device for fixing electronic equipment,
wherein, on a rear side of a mount having the mounting structure and being fixed the joint to the front side, another mount having no mounting structure is magnetically coupled via an intermediate support, and, and allows the elastic spring member to be stored in the mount in a small and compact manner.

### Effects of the Invention

With the mounting device according to the embodiment of the present invention, by using, for example, a resin leaf spring provided with a portion for tension adjustment as the elastic spring member, it becomes possible to adjust the spring tension while keeping the length of the resin leaf spring small, thereby improving elastic deformation, strength, and durability within limited dimensional conditions, and allowing the resin leaf spring to be stored in the mount in a small and compact manner.

According to the embodiment, when the shaft portion of the joint is rotated in a direction and at an angle other than the predetermined direction, the peripheral surface of the shaft portion and the edge of the window interfere with each other, preventing reverse or excessive rotation.

According to the embodiment, the sliding surface of the joint flange and the sliding plane of the elastic leaf spring are metal-to-metal sliding friction surfaces, ensuring strength and durability.

According to the embodiment, this ensures the strength and durability of the friction surface of the flange of the joint on which the resin leaf spring slides.

According to the embodiment, the mount to which the joint is attached with one touch can be easily supported on an intermediate support using another mount.

### BRIEF DESCRIPTION OF THE DRAWINGS

FIG. 1 is a perspective view of a mounting device for fixing an electronic equipment according to a first embodiment of the present invention;

FIG. 2 is an exploded perspective view of the mounting device;

FIG. 3 is a perspective view from the rear side of a joint coupled to an electronic equipment (camera) in the mounting device;

FIG. 4 is a rear view of the joint;

FIG. 5 is a perspective view of an elastic leaf spring in the mounting device;

FIG. 6A is a front view of the mounting device when the joint is not fixed;

FIG. 6B is partial front view of the mounting device in during the progress;

FIG. 6C is partial front view of the mounting device when the joint is fixed;

FIG. 7 is a partial cross-sectional view along line A-A in FIG. 6B;

FIG. 8A is a cross-sectional view of the device in which the mount device is combined with another mount that does not have a mounting structure, when the joint is fixed;

FIG. 8B is cross section of the joint when not fixed;

FIG. 9 is a side view of a device according to another embodiment in which the mount according to the above embodiment is combined with another mount that does not have a mounting structure;

FIG. 10 is a perspective view of a mounting device for fixing an electronic equipment according to a second embodiment of the present invention;

FIG. 11 is an exploded perspective view of the mounting device;

FIG. 12 is a front view of the mount in the mounting device;

FIG. 13 is a perspective view of a joint in the mounting device.

FIG. 14 is a front view of the joint;

FIG. 15 is a perspective view of an elastic leaf spring in the mounting device;

FIG. 16A is a front view of the mounting device when the joint is not fixed;

FIG. 16B is a partial front view of the mounting device in during the progress;

FIG. 16C is a partial front view of the mounting device when the joint is fixed;

FIG. 17A is a partial cross-sectional view along line A-A in FIG. 16A when the joint is not fixed;

FIG. 17B is a partial cross-sectional view along line A-A in FIG. 16B when the joint is during the progress;

FIG. 17C is a partial cross-sectional view along line A-A in FIG. 16C when the joint is fixed;

FIG. 18A is a diagram showing a reverse rotation prevention structure in the mounting device when the joint is not fixed;

FIG. 18B is a diagram showing that the joint is rotatable forwardly for fixing in the above structure;

FIG. 18C is a diagram showing that the reverse direction rotation is prevented in the above structure;

FIG. 19A is a diagram showing a rotation of removing the joint from fixed state in the above structure; and

FIG. 19B is a diagram showing that excessive rotation of the joint is prevented in the above structure.

### DESCRIPTION OF THE EMBODIMENTS

### First embodiment

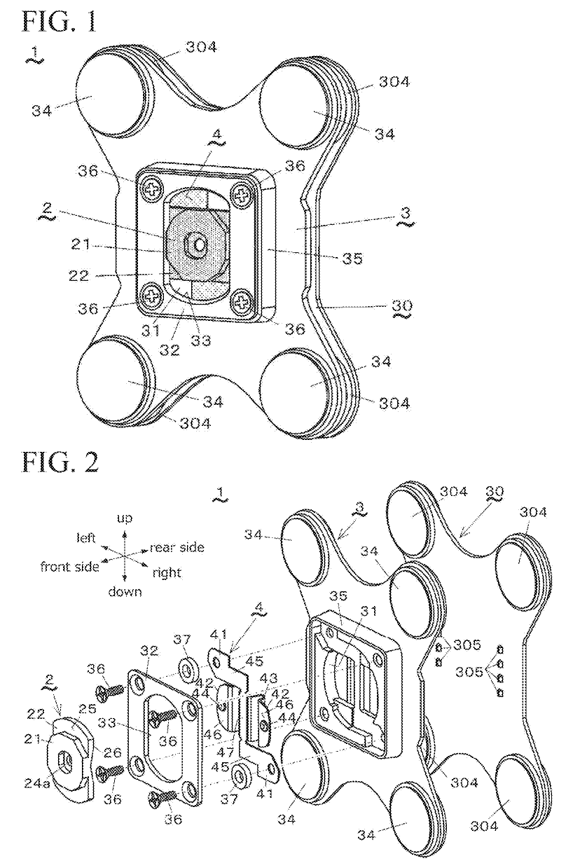

Hereinafter, a mounting device for fixing electronic equipment according to a first embodiment of the present invention will be described with reference to the drawings. FIG. 1 shows a mounting device 1 to which an adapter parts 2 of electronic equipment (such as a camera, wireless device etc. here not shown) is fixed. The adapter parts 2 is coupled to the electronic equipment and for fixing or holding it to the mounting device 1. Hereinafter, the adapter parts 2 will be referred to as a “joint 2”. The mounting device 1 includes a mount 3 which has a mounting structure for fixing the joint 2. FIG. 2 shows the mounting structure of the mount 3 by decomposing the mount 3.

In FIGS. 1 and 2, the mounting device 1 includes the joint 2, and the mount 3 to which the joint 2 is fixed. The joint 2 includes a shaft portion 21, one end of which is coupled to the exterior of the electronic equipment, and a flange 22, which is located on the other end of the shaft portion 21 and at least a portion of which extends outward to a larger diameter than the shaft portion 21.

The mount 3 includes a recessed space 31 into which the flange 22 of the joint 2 is inserted, a cover plate 32 that covers the opening of the recessed space 31, and an elastic spring member, such as a metal leaf spring 4, fixed within the recessed space 31. In this embodiment, the mount 3 has a recessed space 31 is configured by forming a thick peripheral wall 35 that is substantially rectangular in shape in the center when viewed from the front. The cover plate 32 is provided with a window 33 into which the shaft portion 21 and the flange 22 of the joint 2 can be inserted. In this example, the flange 22 has an outer shape of approximately rectangular in rear or front side view, and the window 33 has approximately a rectangular shape of which opposing longitudinal sides are widened in semicircular arcs shape.

Here, another mount 30 having no mounting structure is magnetically coupled to a rear side of the mount 3 having a mounting structure to which the joint 2 is fixed on the front side. The two mounts 3 and 30 are magnetically coupled with each other via an intermediate support (belts, clothing, etc. not shown), and thereby supported by the intermediate support. The two mounts 3 and 30 are formed into a plate shape using resin material or the like, and have the same quadrilateral shape viewed from the front, with magnetic attraction portions 34 and 304 whose corners extend outward and are thicker than the other portions. The magnetic attraction portions 34 and 304 each have a magnet on one side and a magnetic material on the other side. With this configuration, using another mount 30, the mount 3 to which the joint 2 is attached can be easily supported with one touch on the intermediate support.

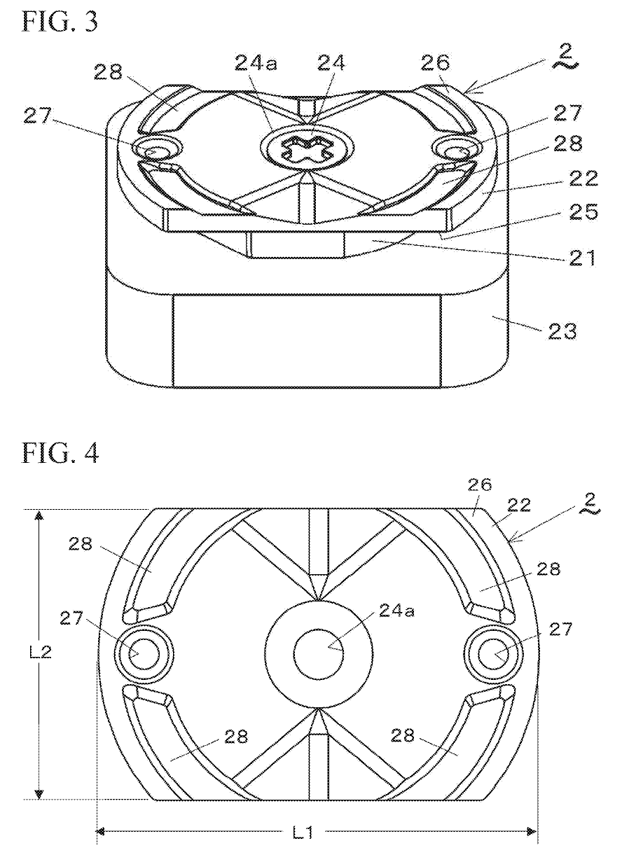

A front side of the shaft portion 21 of the joint 2 shown in FIG. 2 is coupled to a rear or bottom surface of an exterior of an electronic equipment 23 (FIG. 3). The above couple is made by tightening a screw 24 (FIG. 3) through a screw hole 24a that passes through the axial centers of the shaft portion 21 and the flange 22. The shaft portion 21 has a polygonal shape when viewed from the front as shown in FIG. 2, but may have a substantially circular shape. The flange 22 preferably has a shape similar to that of the rectangular window 33 in the cover plate 32.

The metal leaf spring 4 is formed in a substantially flat plate shape and includes a pair of attachment arms 45 having fixed ends 41 and a pair of tension arms 46 having free ends 42. The fixed ends 41 are provided at diagonal positions with respect to the center of the metal leaf spring 4. The tension arms 46 are continuous with the attachment arms 45, extend in a direction (left-right direction in FIG. 2) approximately perpendicular to the long side direction (up-down direction in FIG. 2) of the window 33 of the cover plate 32, and have the free ends 42 at the tip ends of each of them.

The cover plate 32 and the metal leaf spring 4 are fixed by a plurality of screws 36 to a peripheral wall 35 that forms the recessed space 31 of the mount 3. The fixed ends 41 of the metal leaf spring 4 is fixed to a mounting base facing the recessed space 31. The free ends 42 of the tension arms 46 are facing a deep groove portion in the recessed space 31, and movable in the rear side direction. The cover plate 32 is fixed so as to cover the opening of the recessed space 31. The cover plate 32 is made of, for example, a rectangular metal and has screw holes at its four corners, and the metal leaf spring 4 has a screw hole at its fixed ends 41.

A spacer 37 is interposed between the cover plate 32 and the metal leaf spring 4 to form a space between them into which the flange 22 of the joint 2 is pushed and inserted. The screw 36 passes through screw holes in the cover plate 32, the spacer 37 and the metal leaf spring 4 in that order, and is fixed into a screw hole provided in the peripheral wall 35 of the mount 3.

FIG. 3 shows the configuration of the joint 2 coupled to the electronic equipment 23 such as a camera, and FIG. 4 shows the configuration as seen from the rear side of the joint 2. The joint 2 comprises a shaft portion 21 and a flange 22 integrally formed from metal or resin material, and is coupled and fixed to a rear or bottom surface of an exterior of the electronic equipment 23 by the screw 24 passing through a screw hole 24a. The shaft portion 21 is located on the electronic device side. The flange 22 is rectangular and has the same axis as the shaft portion 21, and at least a portion of the flange 22 is extending outward from the shaft portion 21 to a larger diameter.

That is, the long side dimension L1 (FIG. 4) of the flange 22 is slightly smaller than the long side dimension of the window 33 in the cover plate 32, and the short side dimension L2 (FIG. 4) of the flange 22 is equal to the outer diameter of the shaft portion 21 and slightly smaller than the short side dimension of the window 33 in the cover plate 32. The axial length of the shaft portion 21 is greater than the thickness of the cover plate 32, and the axial length of the flange 22 is only required to be equal to the plane spacing dimension between the metal leaf spring 4 and the cover plate 32.

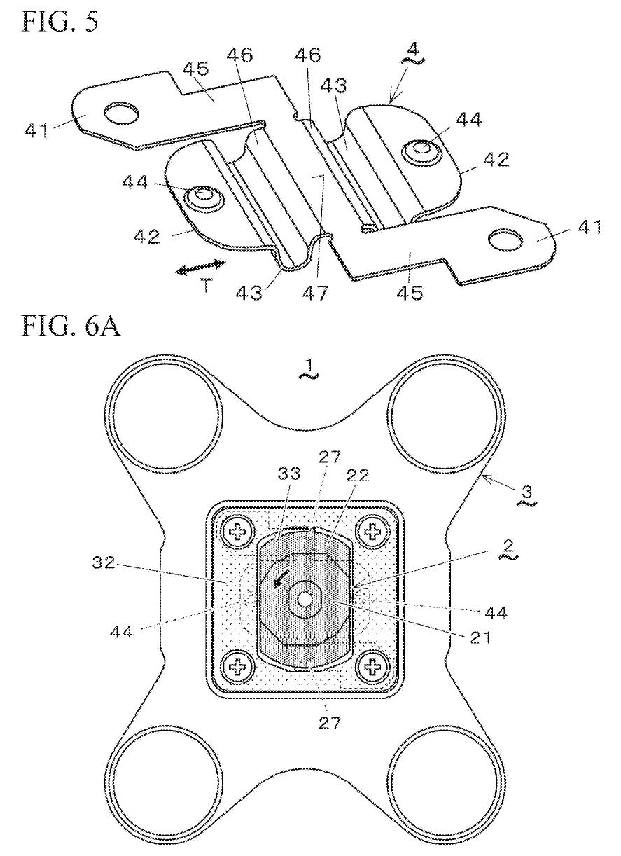

The tip side (rear side) surface of the flange 22 is a sliding surface 26 that slides against a sliding plane 47 (FIG. 5) of the tension arm 46 of the metal leaf spring 4. The sliding surface 26 is provided with a pair of grooves 27 for fixing. By rotating the joint 2 coupled to the electronic equipment 23, the groove 27 of the joint 2 and a protrusion 44 on the free end 42 of the metal leaf spring 4 are engaged each other, and, by this engaging, the joint 2 is fixed surely to the mount 3.

The groove 27 and the protrusion 44 are in a mutually engaging relationship, but may be reversed. The sliding surface 26 is provided with arc-shaped scratch-preventing grooves 28 for preventing scratches from becoming noticeable, caused by the projections 44 of the metal leaf spring 4 sliding against the grooves 27. A surface of the flange 22, that is protruding from the shaft portion 21 and facing to the electronic equipment 23, is a sliding surface 25 (opposite side of the sliding surface 26) for sliding against the inner surface of the cover plate 32.

FIG. 5 shows the metal leaf spring 4. The metal leaf spring 4 includes a pair of attachment arms 45 having fixed ends 41 at diagonal positions relative to the center of the spring, and a pair of tension arms 46 coupled to the attachment arms 45 near the center and having free ends 42 at their tip ends. The free ends 42 are provided with protrusions 44 respectively. The metal leaf spring 4 also has tension arms 46 extending from the fixed ends 41 toward the free ends 42, on which three-dimensional shaped portions 43 for tension adjustment are provided.

A flat portion of the tension arm 46, other than the portion where the three-dimensional shaped portion 43 is provided, forms the sliding plane 47 that slides against the sliding surface 26 of the flange 22. In this embodiment, the three-dimensional shaped portion 43 is formed three-dimensionally in the middle of the tension arm 46, curved in a U-shape in cross section so as to move away from the sliding plane 47.

By using a metal leaf spring 4 provided with such a three-dimensional shaped portion 43, it becomes possible to adjust the spring tension in the direction of the arrow T while keeping the length of the metal leaf spring 4 small. This ensures elastic deformation, strength, and durability within limited dimensional conditions, and makes it becomes possible to store the metal leaf spring 4 in the mount 3 in a small and compact manner.

The metal leaf spring 4 according to this embodiment uses the attachment arm 45 having fixed ends 41 and the tension arm 46 that is coupled to the attachment arm 45 and has the free ends 42, thereby making it possible to increase the length from the fixed ends 41 to the free ends 42 and provide a small and compact elastic spring member.

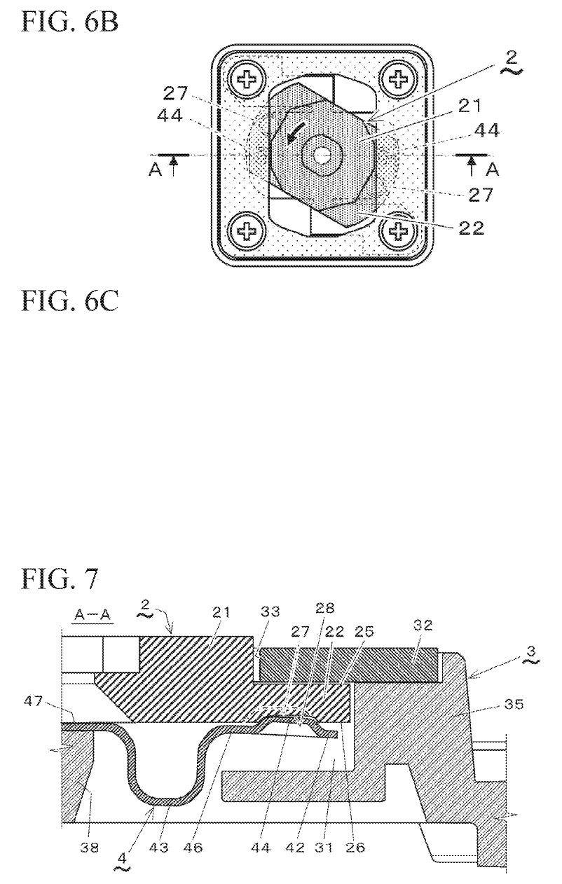

FIGS. 6A, 6B, and 6C are transition diagrams of the joint 2 when not fixed to the mount 3, during the progress, and when fixed. FIG. 7 is a cross section taken along line A-A in FIG. 6B, showing the state during a transition.

As shown in the unfixed state in FIG. 6A, the flange 22 of the joint 2 is inserted into the recessed space 31 through the window 33 with the long side direction of the flange 22 aligned with the long side direction of the window 33. At this time, the sliding surface 25 of the flange 22 on the electronic equipment side and the inner surface of the cover plate 32 are on the same plane, and the sliding surface 26 on the tip side of the flange 22 and the sliding plane 47 of the metal leaf spring 4 are in contact. From this state, the shaft portion 21 of the joint 2 is rotated around its axis in the direction of the arrow in the drawing by a predetermined angle (90 degrees in this example). The shaft portion 21 is positioned to pass through the window 33 and guides the rotation.

Then, as shown in FIG. 6B during the progress (intermediate state), the flange 22 of the joint 2 is pushed into the space between the cover plate 32 and the metal leaf spring 4, and the sliding surface 25 on the electronic equipment side of flange 22 slides against an inner surface of the cover plate 32, and sliding surface 26 on the tip side of flange 22 slides against the sliding plane 47 of the metal leaf spring 4. At this time, since the tension arm 46 has the protrusions 44 at its free ends 42, the tension arm 46 bends as shown in FIG. 7, and the three-dimensional shaped portion 43 effectively acts to adjust the tension. The metal leaf spring 4 is supported on the rear side of the sliding plane 47 by a spring support 38 (FIG. 7) formed on the body of the mount 3.

When the joint 2 is rotated, as shown in FIG. 6C of fixed state, the protrusion 44 (or groove) of the metal leaf spring 4 engages with the groove 27 (or protrusion) provided on the sliding surface 26 of the flange 22. In this way, the joint 2 is securely fixed to the mount 3.

Here, a planar spacing dimension between the metal leaf spring 4 and the cover plate 32 are made approximately the same as the axial dimension of the flange 22 of the joint 2. Then, when the groove 27 (or protrusion) of the flange 22 and the protrusion 44 (or groove) of the metal leaf spring 4 are engaged, even if the metal leaf spring 4 becomes planar and close to its natural state, appropriate tension can be applied to the joint 2 and the flange 22 can be pressed against the inner surface of the cover plate 32. This configuration is desirable, as it allows the joint 2 to be fixed to the mount 3 stably and reliably.

By making the joint 2 out of metal, or by making at least the sliding surface 26 at the axial tip of the flange 22 out of metal, this sliding surface 26 and the sliding plane 47 of the tension arm 46 become a sliding friction surface between metals, thereby increasing durability. Furthermore, if the metal leaf spring 4 made of sheet metal as the elastic spring member is a separate part from the other components of the mount device 1, the strength and durability can be improved and the part can be easily replaced.

It should be noted that the direction of rotation of the shaft portion 21 about its axis during the operation of fixing the joint 2 to the mount 3 may be opposite to that described above. Furthermore, when removing the joint 2 from the mount 3, if the joint 2 is configured so that it can be rotated in either direction, operability will be improved.

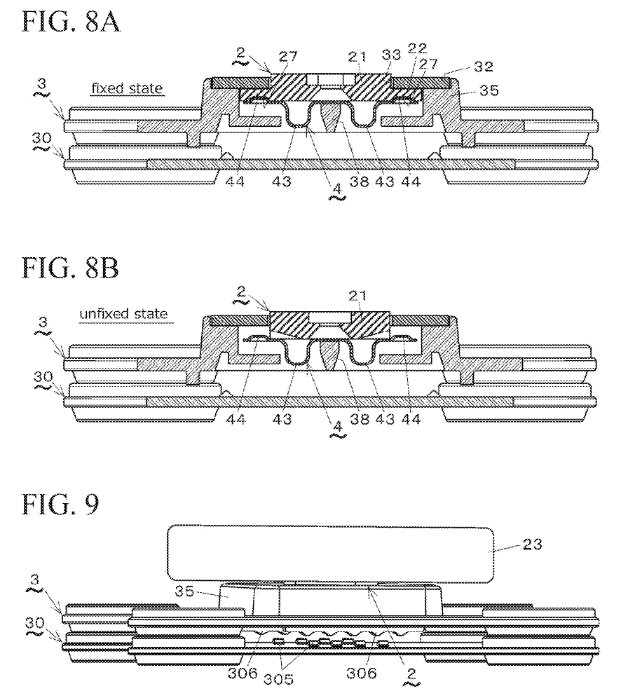

FIG. 8A shows a cross section of the joint 2 when it is fixed, when a mount 3 having a mounting structure is coupled to another mount 30 having no mounting structure. FIG. 8B shows a cross section of the joint 2 when it is not fixed. When fixed, the flange 22 of the joint 2 is pressed between the cover plate 32 and the metal leaf spring 4, and the groove 27 (or protrusion) on the sliding surface 26 of the flange 22 engages with the protrusion 44 (or groove) on the metal leaf spring 4, thereby securely fixing the joint 2 to the mount 3.

When not fixed, the flange 22 of the joint 2 is inserted into the recessed space 31 of the mount 3 through the window 33 of the cover plate 32, and this is the state before the joint 2 is rotated. During the progress from an unfixed state to a fixed state, the metal leaf spring 4 needs to bend when the flange 22 passes over the protrusion 44 of the metal leaf spring 4, but the presence of the three-dimensional shaped portion 43 in the metal leaf spring 4 makes it possible to adjust the tension appropriately while keeping the length restricted.

FIG. 9 shows another embodiment, showing a side view of the mount 3 having a mounting structure and another mount 30 having no mounting structure, when they are joined together. The mount 3 and another mount 30, which are magnetically attracted to each other, have protrusions 305 and 306 for anti-slip on their inner surfaces facing each other. When the mount device 1 is attached to clothing or a belt (not shown) and used, the anti-slip protrusions 305 and 306 bite into the clothing or belt that is to be sandwiched between the mount 3 and the mount 30, and they do not slip out of position.

The present invention is not limited to the configuration of the above embodiment, and various modifications are possible. For example, the metal leaf spring 4 is not limited to the above-mentioned shape of the attachment arms 45 and tension arm 46, but may have at least fixed ends 41 and free ends 42 with the three-dimensional shaped portion 43 provided therebetween, and the three-dimensional shaped portion 43 may have any shape.

Furthermore, the shaft portion 21 and flange 22 of the joint 2 can adopt any shape to match any shape of the window 33 of the cover plate 32. The joint 2 is rotated around its axis by a predetermined angle so that it can be fixed, and this rotation angle is set appropriately depending on the shape of the metal leaf spring 4. The present invention is not limited to a configuration in which the two mounts 3 and 30 are supported by the intermediate support as in the embodiment, and one mount 3 may be held by any support.

In the first embodiment, a metal leaf spring 4 is used as the elastic spring member, but when a metal leaf spring 4 is used, scratches are likely to occur on the sliding surface 26 between the metal leaf spring 4 and the flange 22 of the joint 2. Therefore, it has been discovered that even when a resin elastic spring member is used instead of the metal leaf spring 4, it is possible to appropriately adjust the tension and ensure the strength and durability of the sliding (friction) surface. Such an embodiment will be described below as a second embodiment.

### Second embodiment

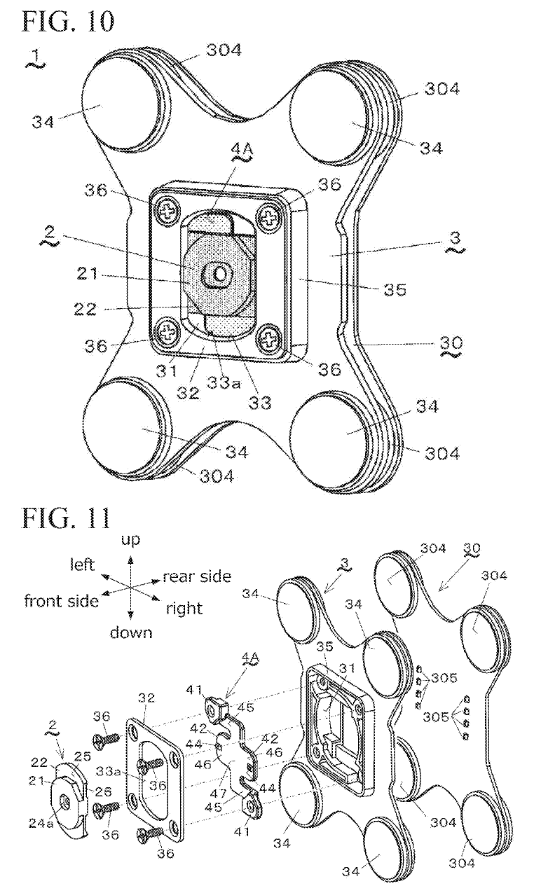

FIG. 10 shows a mounting device 1 for fixing an electronic equipment, with a joint 2 secured to a mount 3. FIG. 11 shows the joint 2 and the mount 3 in disassembled state. In both figures, the equipment, such as a camera to which the joint 2 is coupled, is not shown. In this second embodiment, an elastic spring member uses a resin leaf spring 4A, having a different shape and material instead of the metal leaf spring 4 in the first embodiment.

In FIGS. 10 and 11, the mount device 1 includes the joint 2 that is coupled to an exterior of the electronic equipment, and the mount 3 to which the joint 2 is fixed. The joint 2 includes a shaft 21 having one end coupled to the exterior of the electronic equipment, and a flange 22 located on the other end of the shaft 21 and at least a portion of which extends outward with a larger diameter than the shaft 21. The joint 2 may be coupled to a wireless device or the like instead of a camera.

### Mount configuration

The mount 3 includes a recessed space 31 into which the flange 22 of the joint 2 is inserted, a cover plate 32 that covers an opening of the recessed space 31, and the resin leaf spring 4A that serves as an elastic spring member fixed within the recessed space 31. The mount 3 of this example has the recessed space 31 formed by a thick peripheral wall 35 that is substantially rectangular in shape in the center when viewed from the front. The cover plate 32 is provided with a window 33 into which the shaft portion 21 and the flange 22 of the joint 2 can be inserted. The window 33 in this example has a substantially rectangular shape of which opposing longitudinal sides are widened in semicircular arcs shape.

On the rear side of the mount 3 having a mounting structure to which the joint 2 is fixed on a front side surface, another mount 30 having no mounting structure is magnetically coupled via an intervening support (not shown). These magnetically coupled mounts 3 and 30 are supported on an intermediate support (not shown). The two mounts 3 and 30 are formed into plates made from a resin material or the like, and have magnetic attraction portions 34 and 304 that are the same rectangular shape when viewed from the front, with corners that extend outward and are thicker than the other parts, and these magnetic attraction portions 34 and 304 have a magnet on one side and a magnetic substance on the other side.

### Configuration of joint, etc.

The joint 2, front side of the shaft 21 shown in FIG. 11 is coupled to a rear or bottom surface of the exterior of the electronic equipment such as a camera (not shown). This couple or connection is achieved by tightening a screw into a screw hole 24a that passes through the axial centers of the shaft portion 21 and the flange 22. A plurality of screw holes 24a may be provided side by side. The shaft portion 21 has a polygonal or substantially circular shape when viewed from the front as shown in FIG. 11. The shape of the peripheral surface 21a of the shaft portion 21 will be described in detail later. The flange 22 preferably has a shape similar to that of the window 33 in the cover plate 32.

The resin leaf spring 4A is formed in a substantially flat plate shape and includes a pair of attachment arms 45 having fixed ends 41 and tension arms 46 having free ends 42. The fixed ends 41 are provided at diagonal positions with respect to the center of the resin leaf spring 4A. The tension arms 46 are continuous with the attachment arms 45 and extend in a direction (left-right direction in FIG. 11) approximately perpendicular to the long side direction (up-down direction in FIG. 11) of the window 33 of the cover plate 32, and each have free ends 42 at its tip, with protrusions 44 provided on the free ends 42.

### Mounting structure for resin leaf spring, etc.

The cover plate 32 and the resin leaf spring 4A are fixed by a plurality of screws 36 to a peripheral wall 35 that forms the recessed space 31 of the mount 3. The resin leaf spring 4A has its fixed ends 41 fixed to a mounting base facing the recessed space 31, and the tension arm 46 having free ends 42 facing a deep groove portion in the recessed space 31 and movable toward the rear. The cover plate 32 is fixed so as to cover the opening of the recessed space 31. The cover plate 32 is made of, for example, a rectangular metal and has screw holes at its four corners, and the resin leaf spring 4A has a screw hole at its fixed ends 41.

The cover plate 32 and the resin leaf spring 4A form a space between them into which the flange 22 is pressed and inserted. The screw 36 passes through screw holes in the cover plate 32, and the resin leaf spring 4A in that order, and is fixed into the screw holes provided in the peripheral wall 35 of the mount 3.

### Configuration of joint shaft and flange

In order to fix the joint 2 to the mount 3, the flange 22 of the joint 2 is inserted into the recessed space 31 of the mount 3 through the window 33 of the cover plate 32, and the peripheral surface 21a of the shaft 21 of the joint 2 faces the edge 33a of the window 33. In addition, the peripheral surface 21a of the shaft portion 21 is configured as a combination of an arc shape and a polygonal shape (described in detail later), and this configuration allows the shaft portion 21 to rotate in a predetermined direction and angle without interference between the peripheral surface 21a of the shaft portion 21 and the edge 33a of the window 33. Both long side ends of the flange 22 of the joint 2 are semicircular arc-shaped portions similar to the window 33.

### Mount and joint details

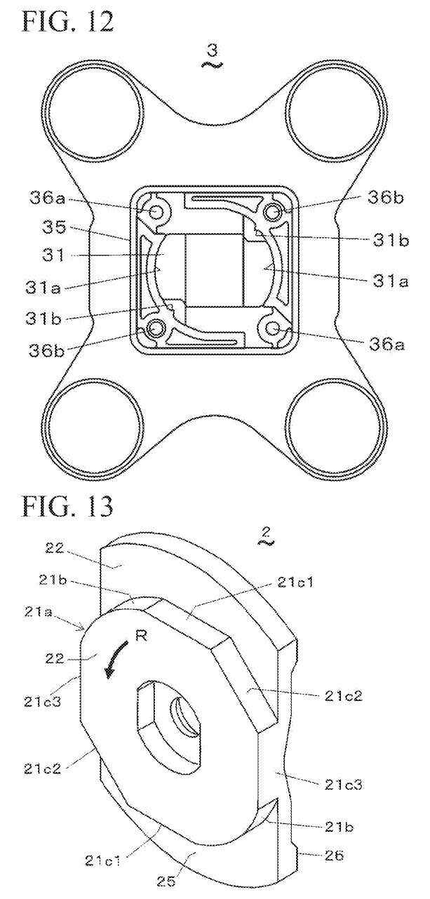

FIG. 12 shows a front of the mount 3 without the cover plate 32 or the resin leaf spring 4A mounted thereon. The mount 3 having a body made of resin forming the recessed space 31, includes a pair of arc-shaped inner walls 31a (31a) for guiding a rotation of the flange 22 on left and right side viewed from the front. The flange 22 has a semicircular arc outer diameter, which is guided by the arc-shaped inner walls 31a (31a). Furthermore, at an end of the arc-shaped inner walls 31a (31a), a pair of anti-rotation protrusions 31b (31b) is formed as a stopper to prevent excessive rotation of the flange 22. The screw holes 36a (36a) at diagonal positions are for fixing the cover plate 32 and the resin leaf spring 4A. The screw holes 36b (36b) are for fixing the cover plate 32.

### Configuration for preventing reverse rotation or excessive rotation

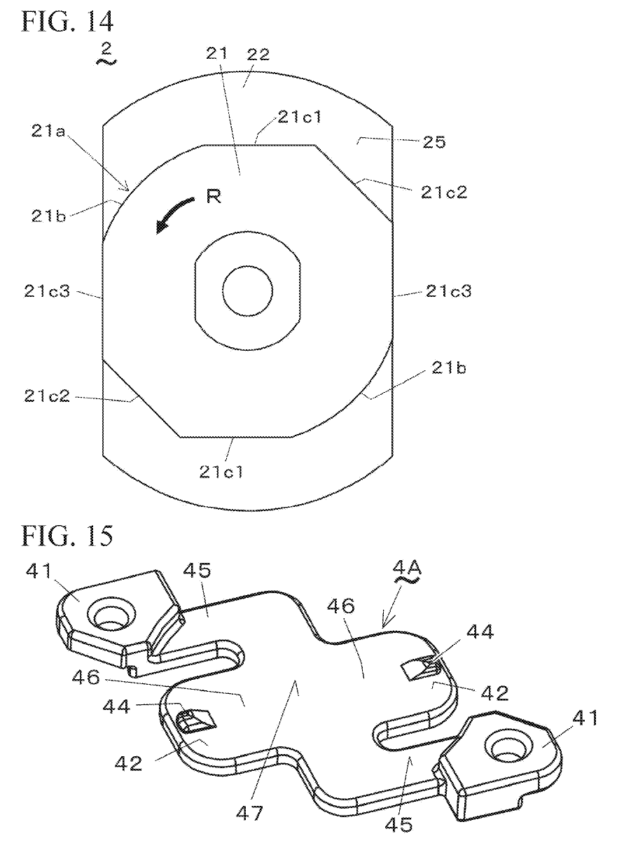

FIGS. 13 and 14 show the configuration of the joint 2. The peripheral surface 21a of the shaft portion 21 of the joint 2 is configured by combining a pair of arc-shaped portions 21b and polygonal portions 21c1, 21c2, and 21c3 that are continuous in the circumferential direction. With this combined configuration, when the shaft portion 21 is rotated in the reverse direction or excessively, the peripheral surface 21a interferes with the edge 33a of the window 33 in the cover plate 32, thereby preventing the shaft portion 21 from rotating in the reverse direction or excessively.

In this example, one arc-shaped portion 21b and polygonal portions 21c1, 21c2, and 21c3 each having three straight sides are arranged in this order in the direction opposite to the rotation direction indicated by the arrow R. One polygonal portion 21c1 (21c2 and 21c3) and another polygonal portion 21c1 (21c2 and 21c3) are located at diagonal positions across the axis, and the arc-shaped portions 21b and 21b are similarly provided. The polygonal portions 21c3 and 21c1, which are located before and after the arc-shaped portion 21b in the direction of arrow R, are positioned at right angles to each other. Surfaces of the polygonal portions 21c3 are flush with the short side surface of the flange 22.

When mounting the joint 2 on the mount 3, the short side of the flange 22 is aligned with the short side of the window 33 of the cover plate 32, and the flange 22 is inserted into the recessed space 31 of the mount 3 through the window 33. At that time, the peripheral surface 21a of the shaft portion 21 faces the edge 33a of the window 33. When the shaft portion 21 is rotated in a predetermined direction from this state to be fixed, the shaft portion 21 can rotate without interfering with the edge 33a of the window 33 due to the combination of shapes of the peripheral surface 21a of the shaft portion 21.

When the shaft 21 is rotated in a direction other than the predetermined direction and angle, the peripheral surface 21a of the shaft 21 and the edge 33a of the window 33 interfere with each other, preventing reverse or excessive rotation. In other words, the shaft portion 21 has a combined shape of the arc-shaped portion 21b and the polygonal portions 21c1, 21c2, and 21c3 on its peripheral surface 21a, so that when the shaft portion 21 is rotated, if its peripheral surface 21a interferes with the window 33, reverse rotation or excessive rotation is prevented. This makes it possible to prevent the mount 3 from being damaged.

The configuration of the joint 2 to the electronic equipment is the same as those in the first embodiment shown in FIGS. 3 and 4, so the above description will be reused and a duplicated description will be omitted.

### Configuration of resin leaf spring

FIG. 15 shows the resin leaf spring 4A that is used in place of a metal leaf spring. The resin leaf spring 4A includes a pair of attachment arms 45 having fixed ends 41 at diagonal positions relative to the center thereof, and a pair of tension arms 46 connected to the attachment arms 45 near the center and having free ends 42 at their tip ends. The free ends 42 is provided with the protrusions 44. The resin leaf spring 4A has tension arms 46 extending from the fixed ends 41 toward the free ends 42, which is used for tension adjustment. A flat portion of the tension arms 46 forms the sliding plane 47 that slides against the sliding surface 26 at the axial tip of the flange 22 of the joint 2.

By using such a resin leaf spring 4A, it is possible to adjust the spring tension while keeping the length of the resin leaf spring 4A small, and it is possible to ensure elastic deformation, strength, and durability within limited dimensional conditions, and it is possible to store the resin leaf spring 4A in the mount 3 in a small and compact manner.

The resin leaf spring 4A of this embodiment uses the tension arms 46 that is connected near the center of an attachment arm 45 having a fixed ends 41 at a diagonal position, extends in a predetermined direction, and has free ends 42 at the tip end, so that the length from the fixed ends 41 to the free ends 42 is increased, making it possible to provide a small and compact elastic spring member.

### Transition to fixing the joint to the mount

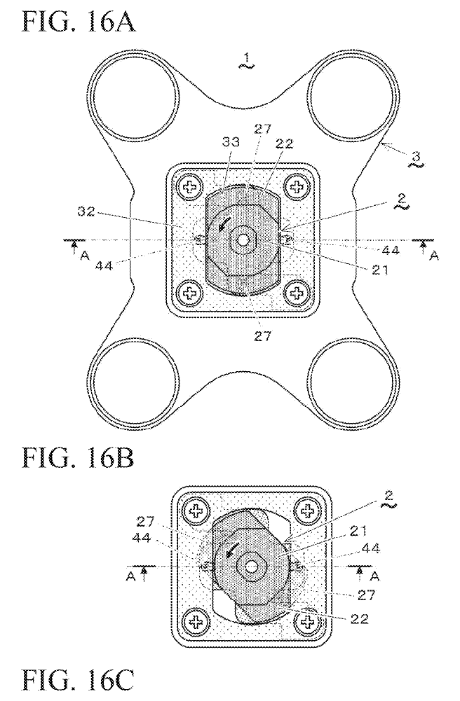

FIGS. 16A, 16B, and 16C are transition diagrams in the mount device 1. FIG. 16A shows a state when the joint 2 is not fixed to the mount 3, FIG. 16B shows a state when it is in the during the progress, and FIG. 16C shows a state when it is fixed. In the unfixed state in FIG. 16A, a long side direction of the flange 22 of the joint 2 is aligned with a long side direction of the window 33 of the cover plate 32, and the flange 22 is inserted into the recessed space 31 (see FIGS. 11 and 12) through the window 33.

At that time, the electronic equipment side’s sliding surface 25 (FIG. 13) of the flange 22 and the inner surface of the cover plate 32 are on the same plane. And the tip side’s sliding surface 26 (FIG. 13) of the flange 22 and the sliding plane 47 (FIG. 15) of the resin leaf spring 4A are in contact. From this state, the joint 2 is rotated by a predetermined angle (90 degrees in this example) in the direction shown by the arrow around the axis of the shaft portion 21. The shaft portion 21 is positioned to pass through the window 33 and guides the rotation.

Then, as shown in FIG. 16B, the flange 22 of the joint 2 is pushed into the space between the cover plate 32 and the resin leaf spring 4A, and the sliding surface 25 (electronic equipment side of the flange 22) slides against the inner surface of the cover plate 32, and the sliding surface 26 (tip side of flange 22) slides against the sliding plane 47 of the resin leaf spring 4A. At this time, since the tension arms 46 of the resin leaf spring 4A has the protrusion 44 at the free ends 42 thereof, the tension arms 46 bends, effectively adjusting the tension.

By further rotating the joint 2, as shown in FIG. 16C, the protrusion 44 (or groove) of the resin leaf spring 4A engages with the groove 27 (or protrusion) provided on the sliding surface 26 of the flange 22. By this engaging, the joint 2 is securely fixed to the mount 3.

Here, it is desirable that a planar spacing dimension between the resin leaf spring 4A and the cover plate 32 is approximately the same as the axial dimension of the flange 22 of the joint 2, so that when the groove 27 (or protrusion) of the flange 22 and the protrusion 44 (or groove) of the resin leaf spring 4A are engaged, appropriate tension is applied to the joint 2 even when the resin leaf spring 4A is in a planar shape close to its natural state, and the flange 22 can be pressed against the inner surface of the cover plate 32. This allows the joint 2 to be fixed to the mount 3 stably and reliably.

Furthermore, if the joint 2 is made of metal, or at least the sliding surface 26 at the axial tip of the flange 22 is made of metal, the sliding surface 26 that slides against the sliding plane 47 of the tension arms 46 of the resin leaf spring 4A will be less likely to be scratched, and will have increased strength and durability. And, if the resin leaf spring 4A is made a separate part from components of the mount 3, it will be easier to replace, then, strength and durability can be improved, and, serviceability can be improved.

### Description of the transition state until fix

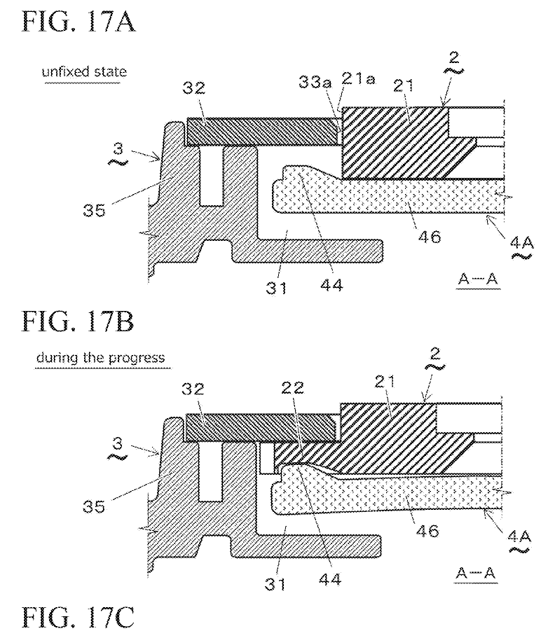

FIG. 17A shows a cross section taken along the line A-A shown in FIG. 16A when the joint 2 is not fixed. FIG. 17B shows a cross section when it is in during the progress, and FIG. 17C shows a cross section when it is fixed. When fixed as shown in FIG. 17C, the flange 22 of the joint 2 is pressed between the cover plate 32 and the resin leaf spring 4A, and the groove 27 (or protrusion) of the flange 22 engages with the protrusion 44 (or groove) on the resin leaf spring 4A, thereby the joint 2 is securely fixed to the mount 3.

In the unfixed state as shown in FIG. 17A, the flange 22 at the end of the shaft portion 21 of the joint 2 is inserted into the recessed space 31 of the mount 3 through the window 33 of the cover plate 32, and this is the state just before the joint 2 is rotated. When the flange 22 of the joint 2 moves (by rotating) over the projection 44 of the resin leaf spring 4A during the transition from unfixed state to fixed state, the resin leaf spring 4A bends. The resin leaf spring 4A allows for appropriate tension adjustment while keeping its length small. Therefore, within limited dimensional conditions, it is possible to improve elastic deformation, strength, and durability, and the resin leaf spring 4A can be housed in the mount in a small and compact manner.

### Prevention from reverse rotation and excessive rotation

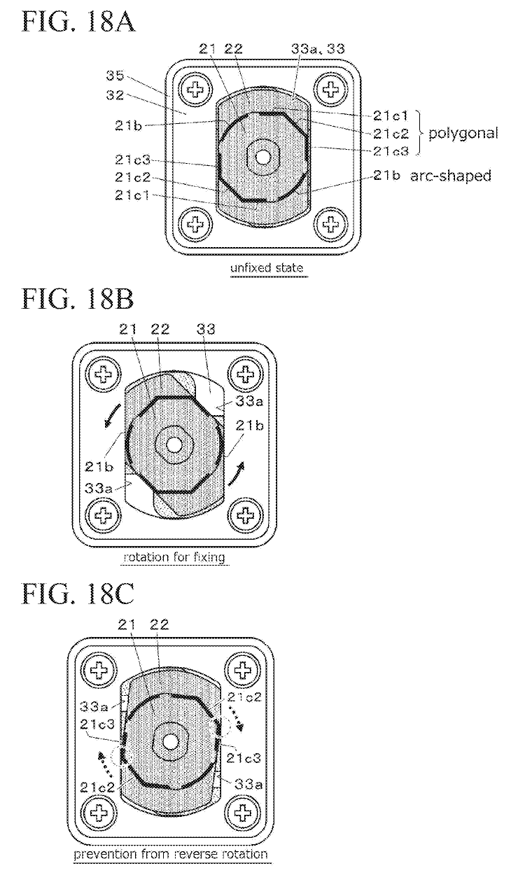

FIGS. 18A, 18B, and 18C show a reverse rotation prevention structure provided by the periphery of the shaft portion 21. FIG. 18A is in unfixed state, FIG. 18B is in rotated forward for fixing, and FIG. 18C is in rotated backward. A structure for preventing reverse rotation during transition, is provided with the window 33 (opening) of the metal cover plate 32 and the shaft portion 21 of the joint 2. It is constituted by a combination of an arc-shaped portion 21b and polygonal portions 21c1, 21c2, and 21c3, provided on the peripheral surface 21a of the shaft portion 21.

In the above, when the shaft portion 21 is rotated forwardly from an unfixed state, as shown in FIG. 18B, the arc-shaped portion 21b conforms to a shape of the window 33, then, the rotation is allowed without interference. When the shaft portion 21is rotated in reverse, as shown in FIG. 18C, the polygonal portion 21c3 interferes with a shape of the window 33, then the reverse rotation is prevented.

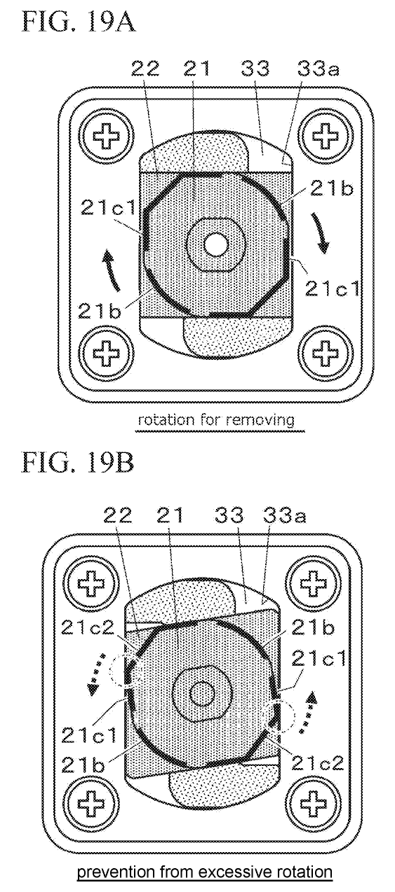

FIG. 19A shows a rotation of the shaft portion 21 from a fixed position to remove, and FIG. 19B shows a prevention of the shaft portion 21 from excessive rotation. A structure for preventing excessive rotation from fixed state, is provided with the window 33 of the metal cover plate 32 and the shaft portion 21 of the joint 2 as above. When the shaft portion 21 is rotated in the removal direction at fixed state, as shown in FIG. 19A, the arc-shaped portion 21b fits along the window 33, so that removal is possible without interference. But, as shown in FIG. 19B, when rotated excessively in the fixing direction, the polygonal portions 21c1, 21c2, and 21c3 interferes, and prevents excessive rotation.

The mount 3 of this embodiment is provided with an anti-rotation protrusion 31b (see FIG. 12) to prevent excessive rotation. With this structure, even if the resin leaf spring 4A is damaged, it will not fall off unless the joint 2 is rotated, providing a simple structure of preventing it from falling off.

In an embodiment such as the rotation direction for fixing the joint 2 is restricted, if the joint 2 is rotated in reverse or excessively, it is easy to lead to damage of the mount 3. But, according to this embodiment, it is intuitively understandable that the reverse rotation is not possible when just a little operated, which increases the effect of preventing damage. And, even if the resin leaf spring 4A is damaged, it is necessary to prevent the joint 2 from easily falling off, and the configuration for preventing reverse rotation or excessive rotation in this embodiment functions as a simple mechanism for preventing falling off.

Conventional resin reverse rotation prevention structures only prevent reverse rotation and do not have a structure to prevent excessive rotation, which raises concerns about damage when excessive force is applied. In contrast, by using a metal cover plate 32 according to this embodiment, this concern is eliminated.

The present invention is not limited to the configuration of the above embodiment, and various modifications are possible. For example, the configuration of the circumferential surface 21a of the shaft portion 21 of the joint 2, which is intended to prevent reverse rotation or excessive rotation, is not limited to the configuration in which the arc-shaped portion 21b and the polygonal portions 21c1, 21c2, and 21c3 are combined, and can be modified as desired.

### DESCRIPTION OF THE REFERENCE NUMERAL

1 mounting device
2 joint
21 shaft portion
21a peripheral surface
21b arc-shaped portion
21c1, 21c2, and 21c3 polygonal portion
22 flange
23 electronic equipment (camera)
24 screw
24a screw hole
25 and 26 sliding surface
27 groove
28 scratch-preventing grooves
3 mount (with mounting structure)
30 another mount (without mounting structure)
304 magnetic attraction portion
305 and 306 anti-slip protrusion
31 recessed space
31a inner wall
31b anti-rotation protrusion
32 cover plate
33 window
33a edge of window
34 magnetic attraction portion
35 peripheral wall
36 screw
36a and 36b screw hole
37 spacer
38 spring support
4 metal leaf spring (elastic leaf spring)
4A resin leaf spring
41 fixed ends
42 free ends
43 three-dimensional shaped portion
44 protrusion
45 attachment arms
46 tension arms
47 sliding plane
L1 long side dimension
L2 short side dimension
T arrow

What is claimed is:

1. Mounting device for fixing electronic equipment comprising:
a joint to be coupled to an exterior of the electronic equipment, and
a mount for fixing the joint;
wherein the joint includes
a shaft portion having one end coupled to the exterior of the electronic equipment, and
a flange located on the other end of the shaft portion, at least the flange of which extends outward with a larger diameter than the shaft portion, and a surface of the flange at the tip end in an axial direction serves as a sliding surface that slides against an elastic leaf spring described later, and the sliding surface is provided with a groove or a protrusion;
wherein the mount includes
a recessed space,
an elastic leaf spring fixed in the recessed space, and
a cover plate covering the recessed space, the cover plate is provided with a window into which the flange of the joint can be inserted;
wherein the elastic leaf spring has a flat portion between its fixed ends and free end, that serves as a sliding plane that slides against the sliding surface of the joint, and the free end is provided with a protrusion or a groove,
the flange of the joint is inserted into the recessed space of the mount through the window of the cover plate, and is rotated around the axis of the joint, thereby being pressed between the cover plate and the elastic leaf spring, and
the joint is fixed to the mount by engaging the groove or protrusion provided on the sliding surface of the flange and the protrusion or groove provided on the elastic leaf spring.

2. The mounting device in accordance with claim 1,
wherein the peripheral surface of the shaft portion of the joint is configured by combining a polygonal shape and a circular arc shape, and
an outer shape of the flange of the joint and the window of the cover plate are approximately rectangular,
the peripheral surface of the shaft portion faces the edge of the window, when the flange is inserted into the recessed space of the mount through the window,
the shaft portion can rotate without interference between the peripheral surface of the shaft portion and the edge of the window, when the shaft portion is rotated to a predetermined direction and a predetermined angle, and
the peripheral surface of the shaft portion and the edge of the window interfere with each other to prevent reverse rotation or excessive rotation, when reverse rotation or excessive rotation occurs.

3. The mounting device in accordance with claim 1,
wherein the sliding surface of the flange and the elastic leaf spring are made of metal,
the elastic leaf spring includes a pair of attachment arms having the fixed ends at diagonal positions, and a tension arm coupled to the attachment arms at a center thereof, wherein the tension arm extends in a direction perpendicular to the long side direction of the window, and its tip side is the free end,
the tension arm includes a sliding plane that slides against the sliding surface of the flange, and a 3D shaped portion that is three-dimensionally curved in a direction away from the sliding plane, and
the sliding surface of the flange and the sliding plane of the elastic leaf spring are metal-to-metal sliding friction surfaces.

4. The mounting device in accordance with claim 1,
wherein the elastic leaf spring is made of resin, and includes a pair of attachment arms having the fixed ends at diagonal positions, and a tension arm coupled to the attachment arms near the center,
the tension arm extends in a direction perpendicular to the long side direction of the window, has a tip end side as the free end, and has a sliding flat surface that slides against the sliding surface of the flange,
the sliding surface of the flange is made of metal, and
the sliding surface of the flange and the sliding plane of the elastic leaf spring are sliding friction surface between metal and resin.

5. The mounting device in accordance with claim 1,
wherein, on a rear side of a mount having the mounting structure and being fixed the joint to the front side, another mount having no mounting structure is magnetically coupled via an intermediate support, and, these two mounts are supported by the intermediate support.
